(19) United States
(12) Patent Application Publication
(10) Pub. No.: US 2013/0305554 A1
(43) Pub. Date: Nov. 21, 2013

(54) Non-contact Sludge Drying System With Flue Gas Heat

(71) Applicant: Xuelue Qian, Shanghai (CN)

(72) Inventor: Xuelue Qian, Shanghai (CN)

(73) Assignee: SHANGHAI FUBO ENVIRONMENTAL EQUIPMENT CO., LTD., Shanghai (CN)

(21) Appl. No.: 13/980,171

(22) PCT Filed: Dec. 19, 2011
(86) PCT No.: PCT/CN2011/084197

§ 371 Date: Jul. 17, 2013

(30) Foreign Application Priority Data
Jan. 21, 2011 (CN) 201110023624.1

(51) Int. Cl. F26B 23/00

(52) U.S. Cl. CPC F26B 23/001
USPC 34/86

(57) ABSTRACT

A non-contact sludge drying system with flue gas heat according to the present invention includes a dryer, and further includes an economizer, a high-temperature flue gas heat recovery device, and an air preheater that are successively disposed in the flue along a flue gas flowing direction. A heater is disposed in the dryer, the high-temperature flue gas heat recovery device is connected to the heater by a circulation pipe, a heat transfer medium is disposed in the circulation pipe, a heat transfer medium driving device is disposed on the circulation pipe, and the dryer is connected to a sludge vapor recovery system. The non-contact sludge drying system with flue gas heat according to the present invention uses the flue gas heat from a thermal power plant boiler or another industrial boiler as a heat source to further dehydrate and dry the dehydrated sludge of the sewage treatment plant, so that the dried sludge can be used as a fuel with certain heat of combustion or composted for further treatment.

### BACKGROUND OF THE INVENTION

1. Field of Invention

The present invention relates to the environmental protection industry regarding boilers and sludge, and more specifically to a non-contact sludge drying system with flue gas heat.

2. Description of Related Arts

Sludge is produced in a procedure of treating sewage by the urban sewage treatment plant, the chemical plant, and the paper mill, and the amount thereof accounts for about 0.5%-0.7% of the total sewage treatment capacity. After simple treatment, the water content of the sludge is about 80%-85%. With the continuous development of national economy, the requirements on the environment become increasingly high. The treatment rate of the sewage across the country is increasingly improved, and the number of the built and the operating sewage treatment plants is continuously increased, resulting in rapidly growing sludge production. According to incomplete statistics, at present, the sewage treatment capacity in the whole country already exceeds 80 million tons per day, and about 60000-ton dehydrated sludge is produced. Currently, the sludge is mainly treated by landfill, composting utilization, and incinerating. However, the sludge treatment manners all have strict requirements on the water content of the sludge. Generally, the water content of the sludge after preliminary treatment by the sewage treatment plant is about 80%, which is far less than that in the process requirements on the sludge treatment manners of composting utilization, incinerating, and so forth; and therefore, the drying of the sludge becomes a necessary procedure in the treatment.

The drying generally includes a mechanical manner and a drying manner using a heat source. The mechanical manner is characterized in that, the machinery can produce a high pressure, and directly acts on the wet sludge, which can rapidly dehydrate the wet sludge completely through the mechanical energy; without using the heat source and the need of heating, no greenhouse gas is thereby produced; the device is closed, so that the sludge does not spill; the odor treatment is centralized, thereby avoiding secondary pollution; the automation level is high, so modular assembly can be performed; the filter plate is automatically flushed by water after the filtering, without the need of an external water source; in the other aspect, the disadvantages thereof are as follows: the one-time investment is high, the running cost is high, and the treated sludge has high water content.

The drying manner using a heat source is accomplished relying on heat energy, and the heat energy is generally produced through energy combustion. The drying manner using a heat source is classified into two kinds according to the forms of heat utilization.

Direct use: the high-temperature flue gas is guided into a dryer, and heat exchange is performed in the contact and convection between the gas and the wet material. Such a manner has high utilization of the heat energy; however, if the dried material has a degree of polluting, the problems regarding the emission are incurred; as the entering of high-temperature flue gas is continuous, the waste gas with the equivalent flow and directly contacted the material has to be exhausted after special treatment.

Indirect use: the heat energy of the high-temperature flue gas is transferred to a certain medium through a heat exchanger, and the medium may be heat-transfer oil, vapor, or air. The medium circulates in a closed loop, and does not contact the dried material. The flue gas, heat energy of which has been partially used, is normally exhausted. The indirect use results in a certain degree of heat loss.

For the drying process, the direct or the indirect heating results in different loss of thermal efficiency, and has different effects on the environment. The cost of the drying mainly lies in the heat energy, so the key of reducing the cost is whether an appropriate heat source can be selected and used. Generally speaking, the waste and hot flue gas originating from the large-scale and environmentally-friendly infrastructure (the waste incinerator, the power station, the kiln, and the chemical equipment) is zero-cost energy, and if used, may become the best energy for the drying. The flue gas exhausted from the boiler contains acid gas, and flows through the heating surfaces of the boiler in a gaseous form when the flue gas is of high temperature till it is removed in the desulfurization tower. When the temperature of the flue gas is lower than a certain degree, the flue gas and the vapor in the flue gas are combined into sulfuric acid to corrode the heat exchanger. To avoid acid dew corrosion on the heating surfaces at the tail of the boiler, generally, the exhaust gas temperature for the boiler is set to be very high, which is around 140 for a new boiler and usually reaches up to 170 after running for a period. The flue gas of this part generally dews when the gas temperature is lower than that of the acid dew point, to corrode the heat exchanger, which is a problem cannot be avoided in both the direct drying and the indirect drying.

The patent No. CN1686879A entitled “Tandem Sludge Drying System with Flue Gas Heat of Thermal Power Plant” discloses a contact sludge drying system directly using flue gas. For the contact drying directly using flue gas, in addition to the problem of acid dew corrosion, the flue gas already used to dry the sludge needs to be treated again, which incurs a high volume of the flue gas and has a high treatment cost. In the non-contact drying indirectly using the flue gas, the gas is converted into hot water at the exhaust gas temperature of 140, which has a lower grade than the flue gas contact drying manner and has higher requirements on the dryer.

### SUMMARY OF THE INVENTION

The problem to be solved by the present invention is to provide a non-contact sludge drying system with flue gas heat, so as to solve the foregoing problems in the prior art.

A non-contact sludge drying system with flue gas heat according to the present invention comprises a dryer, and further comprises an economizer, a high-temperature flue gas heat recovery device, and an air preheater that are successively disposed in the flue along a flue gas flowing direction. A heater is disposed in the dryer, the high-temperature flue gas heat recovery device is connected to the heater by a circulation pipe, a heat transfer medium is disposed in the circulation pipe, a heat transfer medium driving device is disposed on the circulation pipe, and the dryer is connected to a sludge vapor recovery system.

The present invention further comprises a low-temperature flue gas heat recovery device, consisting of a heat-absorption segment and a heat-dissipation segment that are connected, wherein the heat-absorption segment is disposed in the flue at the rear of the air preheater, and an air outlet of the heat-dissipation segment is connected to the air preheater.

In the present invention, a temperature sensor is disposed on the heat-absorption segment, an electric control valve is disposed on the circulation pipe connecting the high-temperature flue gas heat recovery device and the dryer, and the temperature sensor and the electric control valve are both connected to a control device.

In the present invention, the heat transfer medium is vapor or hot water, and the heat transfer medium driving device is a circulation pump.

In the present invention, the heat transfer medium is vapor or hot water, and the heat transfer medium driving device is a circulation pump.

The sludge vapor recovery system of the present invention comprises a condenser, a circulating fan, and a sewage treatment system, wherein the condenser is connected to the dryer through a circulation air pipe, a circulating fan is disposed on the circulation air pipe, and a water outlet of the condenser is connected to the sewage treatment system.

In the present invention, a spray head is disposed in the condenser, and the spray head is connected to a water supply pump.

Through the foregoing technical solutions, the non-contact sludge drying system with flue gas heat of the present invention is different from other drying systems directly enabling the flue gas to contact the sludge, which first converts the boiler flue gas heat into vapor, hot water, or hot wind, and then heats the sludge with the vapor, the hot water, or the hot wind to dry the sludge, and maximizes the use of the flue gas heat in the case of avoiding the flue gas acid dew corrosion, thereby reducing the energy consumption in the sludge drying and decreasing the operation cost of the sludge drying.

### BRIEF DESCRIPTION OF THE DRAWINGS

FIG. 1 is a structural view of a first specific embodiment consistent with the present invention.

FIG. 2 is a structural view of a second specific embodiment consistent with the present invention.

List of the numerals: 1. economizer, 2. high-temperature flue gas heat recovery device, 3. air preheater, 4. boiler tail flue, 5. heat-absorption segment, 6. heat-dissipation segment, 7. control device, 8. circulating fan, 9. condenser, 10. water supply pump, 11. sludge bin, 12. dryer, 13. circulation pump, 14. electric control valve, 15. fan, 16. dryer, 17. sewage treatment system, 18. condensing nozzle, and 19. temperature sensor.

### DETAILED DESCRIPTION OF THE PREFERRED EMBODIMENTS

The non-contact sludge drying system with flue gas heat of the present invention is described in detail below with reference to the specific embodiments.

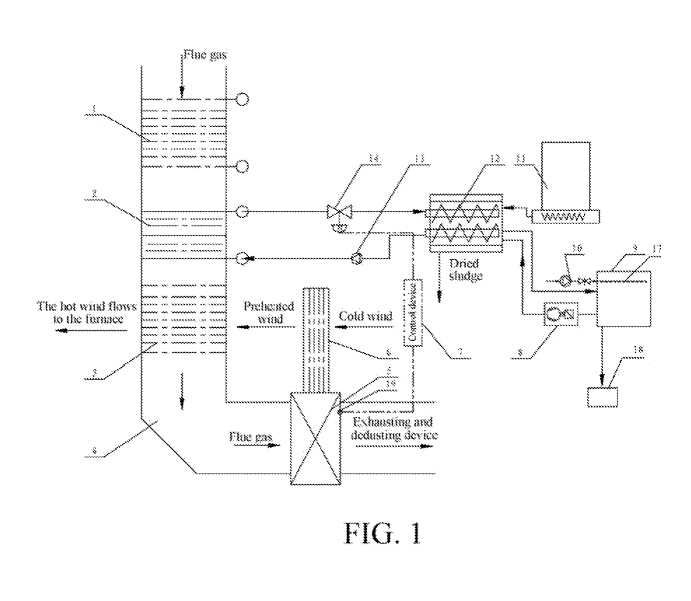

As shown in FIG. 1, a specific embodiment of a non-contact sludge drying system with flue gas heat according to the present invention is provided, in which the sludge is dried by using vapor and hot water as a heat transfer medium. The system includes a sludge bin 11 and a dryer 12 that are successively connected, and further includes an economizer 1, a high-temperature flue gas heat recovery device 2, and an air preheater 3 that are successively disposed in a boiler tail flue 4 along a flue gas flowing direction. The high-temperature flue gas heat recovery device 2 is connected to a heater in the dryer by a circulation pipe, a heat transfer medium is disposed in the circulation pipe, and a heat transfer medium driving device and an electric control valve 14 are disposed on the circulation pipe. The heat transfer medium is vapor or hot water, and the heat transfer medium driving device is a circulation pump; the electric control valve 14 is disposed on a pipeline through which the vapor or hot water flows from the high-temperature flue gas heat recovery device 2 to the dryer 12; and the circulation pump 13 pumps the vapor or hot water back into the high-temperature flue gas heat recovery device 2.

The water content of the dehydrated sludge from the sewage treatment plant is generally around 80%. The sludge is stored in the sludge bin 11. A push plate device is disposed in the sludge bin 11 and runs through a hydraulic or an electrical device to prevent the sludge from hardening into slag to affect the discharging. The dryer 12 transfers the heat energy of the vapor or hot water to the sludge, so that the moisture of the sludge is evaporated and is taken out by the circulating air. The present invention further includes a sludge vapor recovery system. A circulating fan 8 in the sludge vapor recovery system pumps the vapor and part of volatile gas that are produced by the sludge dryer 12 into a condenser 9 through a circulation air pipe, and the vapor and the gas are condensed and then enter the dryer 12. The condenser 9 adopts a condensing manner of water spraying. The condensate water comes from a pool, enters the spraying condenser through a water supply pump 10, is nebulized through a spray head 18, and then fully contacts the circulating air; the air is exhausted from an upper portion of the condenser 9 after being cooled, part of vapor is condensed into liquid water after the air is cooled, and the liquid water with the condensate water is exhausted from a water outlet at the bottom of the condenser and enters the sewage treatment system 17 for treatment. The dryer of one or more levels may be designed according to the sludge treatment capacity, the sludge drying degree, and the temperature and flow of the flue gas.

As part of volatile gas in the sludge continuously enters the circulating air, the circulating air is increased in the volume. An exhaust pipe is mounted on a circulating air pipeline, the gas enters the nearby incinerator through the exhaust pipe, the energy of the volatile gas is recovered through incinerating and stench is eliminated accordingly; or other treatment manners are adopted, so as to reduce the environmental pollution.

The outlet gas temperature of the economizer 1 is different in different furnaces. Generally speaking, at around 300, the heat energy is transferred through exchange to the cold wind through the air preheater 3, the heated cold wind then flows to the furnace of the boiler as a wind supply for the combustion; the flue gas is cooled and then exhausted to the outside after dedusting and desulfurization. A high-temperature flue gas heat recovery device 2 is mounted between the economizer 1 and the air preheater 3. As the temperature of the flue gas reaches about 300, vapor or hot water with a high grade for the sludge drying may be produced, and may be selected according to different driers. The heat energy of such a part is pumped, which inevitably affects the heat exchange effect of a lower-level air preheater 3, so that the heat exchange amount of the air preheater 3 is reduced; as a result, the exhaust gas temperature is lower than that when the high-temperature flue gas heat recovery device is not mounted. To compensate for the reduction of the heat energy of the air preheater, a low-temperature flue gas heat recovery device is mounted after the air preheater 3. The low-temperature flue gas heat recovery device includes a heat-absorption segment 5 and a heat-dissipation segment 6 that are connected. The heat-absorption segment is disposed in the flue at the rear of the air preheater, the heat-dissipation segment 6 is disposed in the flue at the inlet of the air preheater, and the heat energy recovered by the heat-absorption segment is returned to the air preheater 3 by the heat-dissipation segment 6.

To prevent wall surfaces of the heat-dissipation segment 6 of the low-temperature flue gas heat recovery device from being corroded by the flue gas acid dew, the present invention further includes a gas temperature control system. A temperature sensor 19 is disposed on the heat-absorption segment, an electric control valve 14 is disposed on the pipeline connecting the high-temperature flue gas heat recovery device 2 and the sludge dryer 12, and the temperature sensor 19 is connected to the electric control valve 14 through a control device 7. The temperature of the wall surfaces of the heat-absorption segment of the heat recovery device is controlled by adjusting the flow of the heat transfer medium, and is enabled to be higher than the temperature of the acid dew point of the flue gas, thereby preventing the device from being corroded by the acid dew.

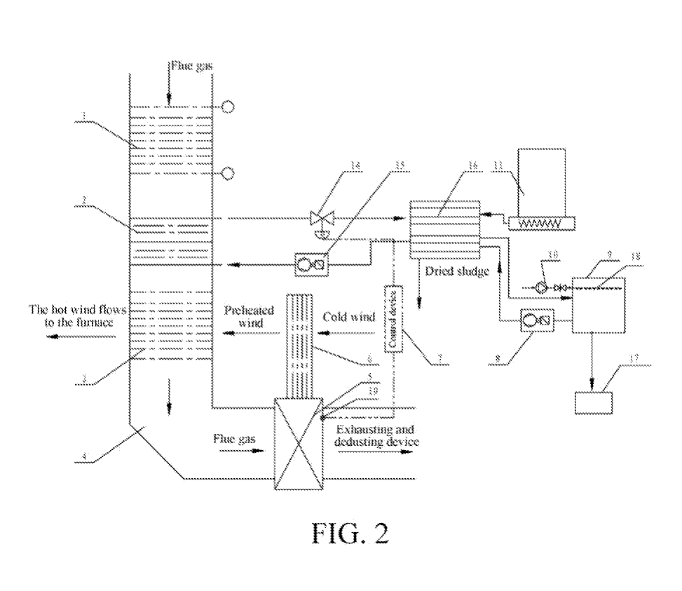

As shown in FIG. 2, another specific embodiment of a non-contact sludge drying system with flue gas heat according to the present invention is provided, in which the hot wind is used as the heat transfer medium to dry the sludge. The system includes a dryer 16, and further includes an economizer 1, a high-temperature flue gas heat recovery device 2, and an air preheater 3 that are successively disposed in a boiler tail flue 4 along a flue gas flowing direction. The high-temperature flue gas heat recovery device 2 is connected to a heater in the dryer through a circulation pipe, a heat transfer medium is disposed in the circulation pipe, the heat transfer medium is hot wind, an electric control valve 14 is disposed on a pipeline through which the hot wind flows from the high-temperature flue gas heat recovery device 2 to the dryer 16, and the hot wind is pumped back to the high-temperature flue gas heat recovery device 2 with a fan 15. The dryer 16 has an internal structure applicable to the case that the heat transfer medium is hot wind, and the dryer 12 has an internal structure applicable to the case that the heat transfer medium is vapor or hot water. Other structures of this embodiment are the same as those in the foregoing embodiment.

The foregoing two specific embodiments describe in detail a non-contact sludge drying system with flue gas heat according to the present invention, but the present invention is not limited to the foregoing two embodiments, and those equivalent to or same as the technical solutions and falling within the scope of the claims of the present invention are protected by the present invention.

What is claimed is:

1. A non-contact sludge drying system with flue gas heat, comprising a dryer (12, 16), and further comprising an economizer (1), a high-temperature flue gas heat recovery device (2), and an air preheater (3) that are successively disposed in a flue along a flue gas flowing direction, wherein a heater is disposed in the dryer (12, 16), the high-temperature flue gas heat recovery device (2) is connected to the heater by a circulation pipe, a heat transfer medium is disposed in the circulation pipe, a heat transfer medium driving device is disposed on the circulation pipe, and the dryer is connected to a sludge vapor recovery system.

2. The sludge drying system as in claim 1, further comprising a low-temperature flue gas heat recovery device, consisting of a heat-absorption segment (5) and a heat-dissipation segment (6) that are connected, wherein the heat-absorption segment (5) is disposed in the flue at the rear of the air preheater (3), and the heat-dissipation segment (6) is disposed in a pipeline at an air inlet of the air preheater (3).

3. The sludge drying system as in claim 2, wherein a temperature sensor (19) is disposed on the heat-absorption segment (5), an electric control valve (14) is disposed on the circulation pipe connecting the high-temperature flue gas heat recovery device (2) and the dryer (12, 16), and the temperature sensor (19) and the electric control valve (14) are both connected to a control device (7).

4. The sludge drying system as in claim 1, wherein the heat transfer medium is vapor or hot water, and the heat transfer medium driving device is a circulation pump (13).

5. The sludge drying system as in claim 1, wherein the heat transfer medium is hot wind, and the heat transfer medium driving device is a fan (15).

6. The sludge drying system as in claim 1, wherein the sludge vapor recovery system comprises a condenser (9), a circulating fan (8), and a sewage treatment system (17), the condenser (9) is connected to the dryer (12, 16) through a circulation air pipe, a circulating fan (8) is disposed on the circulation air pipe, a water outlet of the condenser is connected to the sewage treatment system.

7. The sludge drying system as in claim 1, wherein a spray head (18) is disposed in the condenser (9), and the spray head (18) is connected to a water supply pump (10).
